(19) United States
(12) Patent Application Publication
(10) Pub. No.: US 2017/0146244 A1
(43) Pub. Date: May 25, 2017

(54) CONTINUOUS ROTATING DETONATION ENGINES AND ASSOCIATED SYSTEMS AND METHODS

(71) Applicant: University of Washington, Seattle, WA (US)

(72) Inventors: Mitsuru Kurosaka, Seattle, WA (US); Carl Thomas Knowlen, Seattle, WA (US); Robert E. Breidenthal, Seattle, WA (US); Arthur Thomas Mattick, Seattle, WA (US); Jacob A. Boening, Seattle, WA (US); Joseph D. Heath, Seattle, WA (US)

(21) Appl. No.: 15/356,310

(22) Filed: Nov. 18, 2016

Related U.S. Application Data
(60) Provisional application No. 62/258,286, filed on Nov. 20, 2015.

(51) Int. Cl. F23R 7/00; F02C 7/264; F23R 3/10; F02C 3/14; F23R 3/50; F23R 3/28

(52) U.S. Cl. CPC F23R 7/00; F23R 3/50; F23R 3/28; F23R 3/10; F02C 3/14; F02C 7/264

(57) ABSTRACT

Continuous rotating detonation engines including an annular combustion chamber formed between substantially concentric inner and outer cylindrical shells. A plurality of ignition devices extend into the annular combustion chamber and can be positioned around a circumference of at least one of the inner and outer cylindrical shells. Each ignition device is operative to provide ignition energy to the combustion chamber upon respective activation thereof. A plurality of injection openings extend radially through at least one of the inner and outer cylindrical shells for fluid communication with the annular combustion chamber.

### CROSS-REFERENCE TO RELATED APPLICATION(S)

This application claims the benefit of pending U.S. Provisional Application No. 62/258,286, filed Nov. 20, 2015, which is incorporated herein by reference in its entirety.

### TECHNICAL FIELD

The present technology generally relates to continuous rotating detonation engines, which are also called rotating detonation engines or pressure gain combustors. In particular, some embodiments of the present technology include systems and methods for fuel and oxidizer mixing and detonation wave initiation for continuous rotating detonation engines.

### BACKGROUND

Continuous rotating detonation engines (CRDEs) take advantage of the inherent energy and thermodynamic efficiency of a shock wave. A typical CRDE includes an annular combustion chamber closed at one end and open at the opposite end. In a conventional CRDE, fuel and oxidizer are introduced axially into the combustion chamber and ignited to begin deflagration burning. Subsequently, a spinning detonation wave is created by a pre-detonator positioned tangentially with respect to the annular combustion chamber. The temperature increase across the spinning detonation wave is generated by combustion, which is intended to sustain and drive the spinning detonation wave circumferentially at supersonic speed. The burned gas is then discharged continuously out the open end (e.g., exit) of the combustion chamber, thereby generating thrust. While CRDEs have shown promise compared with many traditional propulsion systems, current CRDE technology continues to suffer because of the instability of the detonation wave, and the ineffectiveness of conventional CRDEs in addressing this issue.

### BRIEF DESCRIPTION OF THE DRAWINGS

FIG. 1 is an isometric view of a CRDE configured in accordance with an embodiment of the present technology.

FIG. 2 is a side view in cross-section of the CRDE shown in FIG. 1.

FIG. 3 is an enlarged portion of the cross-section shown in FIG. 2.

FIG. 4 is an isometric view of a manifold insert configured in accordance with an embodiment of the present technology.

FIG. 5 is an isometric view of a manifold insert configured in accordance with another embodiment of the present technology.

FIG. 6 is a schematic diagram of fuel and oxidizer mixing as viewed from an end of the CRDE.

FIG. 7A is a schematic diagram illustrating an ignition sequence in accordance with an embodiment of the present technology.

FIG. 7B is a schematic diagram illustrating an ignition sequence in accordance with another embodiment of the present technology.

FIG. 8 is a schematic diagram illustrating a CRDE configured in accordance with another embodiment of the present technology.

FIG. 9 is a schematic diagram illustrating a portion of a combustion chamber in accordance with embodiments of the present technology.

FIG. 10A is a schematic diagram illustrating an example of conventional axial fuel and oxidizer injection.

FIG. 10B is a schematic diagram illustrating another example of conventional fuel and oxidizer injection.

FIG. 11 is a schematic diagram illustrating an end view of a conventional CRDE with a tangentially positioned pre-detonation tube.

### DETAILED DESCRIPTION

The present technology relates generally to systems and methods for fuel and oxidizer mixing and detonation wave initiation for CRDEs. It has been observed that when multiple detonation waves are present in the annulus of a CRDE, they have a tendency to reverse directions. This phenomenon often causes two waves to collide, causing unstable operation. Embodiments of the present technology avoid these problems with a circumferential array of spark plugs activated in succession to create acoustic waves within the annulus of the CRDE. As the reactants (e.g., fuel and oxidizer) enter the annulus, these acoustic waves transform into stable detonation waves. Embodiments of the present technology also facilitate maximizing the output energy of the fuel and oxidizer through efficient mixing of the reactants. The disclosed designs, for example, facilitate large vortices of both fuel and oxidizer to interact and mix very quickly.

In one embodiment of the present technology, for example, a continuous rotating detonation engine includes an annular combustion chamber formed between substantially concentric inner and outer cylindrical shells. A plurality of ignition devices extend into the annular combustion chamber and can be positioned around a circumference of at least one of the inner and outer cylindrical shells. Each ignition device is operative to provide ignition energy to the combustion chamber upon respective activation thereof. A plurality of injection openings extend through at least one of the inner and outer cylindrical shells for fluid communication with the annular combustion chamber. In certain aspects, for example, the inner and outer cylindrical shells extend along an engine axis and the plurality of ignition devices are equidistantly spaced around the circumference of the outer cylindrical shell, each extending along an ignition plane oriented perpendicular to the engine axis. In certain aspects, for example, the plurality of injection openings include inner injection openings and outer injection openings extending through the inner and outer cylindrical shells, respectively, the inner injection openings being circumferentially offset from the outer injection openings. The inner and outer injection openings can each extend along an injection plane oriented perpendicular to the engine axis. The continuous rotating detonation engine may also include a controller including instructions to activate the plurality of ignition devices in consecutive sequence around the circumference of the outer cylindrical shell for a preselected number of revolutions. The controller can include instructions to activate the plurality of ignition devices in diametrically opposed pairs. The continuous rotating detonation engine also includes an inner annular manifold in fluid communication with the inner injection openings and connectable to one of a source of oxidizer and a source of fuel, and an outer annular manifold in fluid communication with the outer injection openings and connectable to the other of the source of oxidizer and the source of fuel. In certain aspects, for example, the plurality of injection openings and the plurality of ignition devices each extend radially into the combustion chamber.

In another embodiment of the present technology, a continuous rotating detonation engine includes an outer cylindrical shell and an inner cylindrical shell positioned concentrically within the outer cylindrical shell to at least partially define an annular combustion chamber therebetween. A chamber end wall extends between the outer cylindrical shell and the inner cylindrical shell. A plurality of ignition ports extend radially through at least one of the inner and outer cylindrical shells and into the combustion chamber. A plurality of outer injection openings are located proximate the chamber end wall and extend radially through an outer surface of the combustion chamber and a plurality of inner injection openings are located proximate the chamber end wall and extend radially through an inner surface of the combustion chamber.

The inner and outer cylindrical shells extend along an engine axis and the end wall lies on an end plane perpendicular to the engine axis. The continuous rotating detonation engine can include an inner annular manifold in fluid communication with the plurality of inner injection openings and an outer annular manifold in fluid communication with the plurality of outer injection openings. In certain aspects, for example, the plurality of inner injection openings are circumferentially offset from the plurality of outer injection openings. The inner and outer injection openings can each extend along an injection plane oriented perpendicular to the engine axis. The inner and outer manifolds are each connectable to one or the other of a source of oxidizer and a source of fuel. The continuous rotating detonation engine also includes a plurality of spark plugs, each coupled to a corresponding one of the plurality of ignition ports and operative to provide ignition energy to the combustion chamber upon activation thereof. The continuous rotating detonation engine can also include a controller including instructions to activate the plurality of spark plugs in consecutive sequence around a circumference of the combustion chamber.

In another embodiment of the present technology, a method of operating a continuous rotating detonation engine includes sequentially activating a plurality of ignition devices positioned around an annular combustion chamber and radially injecting fuel and oxidizer into the annular combustion chamber. The method can include activating the plurality of ignition devices diametrically opposed pairs. For example, the plurality of ignition devices may be activated in consecutive sequence around the combustion chamber. In certain aspects, the plurality of ignition devices are activated in consecutive sequence around the combustion chamber for a preselected number of revolutions. The method can further include injecting the fuel and oxidizer at a plurality of locations around an inner and an outer circumference of the combustion chamber.

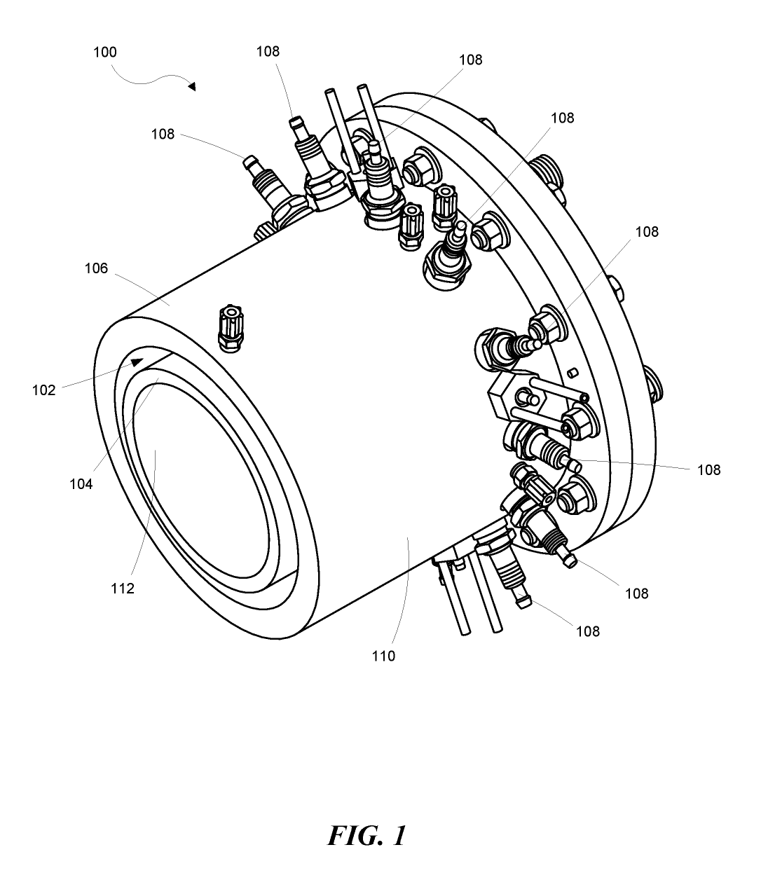

These and other aspects of the present technology are described in greater detail below. Certain details are set forth in the following description and in FIGS. 1-11 to provide a thorough understanding of various embodiments of the present technology. Other details describing well-known systems and methods often associated with operation of a CRDE (e.g., fuel supply connections and spark plug operation), and/or engine control system electronics hardware have not been set forth in the following disclosure to avoid unnecessarily obscuring the description of the various embodiments.

In the Figures, identical reference numbers identify identical, or at least generally similar, elements. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the invention can be practiced without several of the details described below.

### I. Selected Embodiments of CRDEs and Associated Methods of Use

As noted above, a CRDE uses shock-induced combustion or detonation to provide thrust. Fuel is burned by transverse shock waves spinning in an annulus. The high pressure behind the shock drives the shock to spin. The shock also acts as a “bladeless” compressor. A CRDE can be characterized as a pressure gain combustor. CRDEs are useful in applications where thrust is needed from a relatively small and efficient package. For example, a CRDE can be positioned in the bypass duct of a gas turbine to act as an in-duct burner. The pressure gain produced by the CRDE can increase the bypass thrust approximately five times. In some applications, this in-duct burning can replace afterburners. In other applications, a CRDE can be used as a ramjet throughout the flight of a vehicle. The pressure gain in a CRDE can provide standing thrust; therefore, a vehicle including a CRDE can take off without boosters or a carrier aircraft, for example. For rocket applications, pressure gained in the combustion chamber can be used to reduce the feed pressure, resulting in smaller turbo-pumps, thereby saving weight and space.

FIG. 1 is an isometric view of a CRDE 100 configured in accordance with an embodiment of the disclosed technology. The CRDE 100 includes, for example, an annular combustion chamber 102 formed between an inner cylindrical shell 104 and an outer cylindrical shell 106 positioned substantially concentric with the inner cylindrical shell 104. A plurality of ignition devices, such as spark plugs 108, extend into the annular combustion chamber 102 and are positioned around an outer circumference 110 of the outer cylindrical shell 106. Each ignition device 108 is operative to provide ignition energy to the combustion chamber 102 upon respective activation thereof. Although the illustrated embodiment is shown to have twelve ignition devices 108, it should be appreciated that additional or fewer ignition devices may be used in similar systems. In some embodiments, for example, the CRDE 100 can include six, eight, ten, or twelve ignition devices. In some embodiments, the ignition devices 108 can be positioned around an inner circumference 112 of the inner cylindrical shell 104 and/or the outer circumference 110 of the outer cylindrical shell 106. In some embodiments, the ignition devices 108 can be equidistantly spaced around the combustion chamber 102.

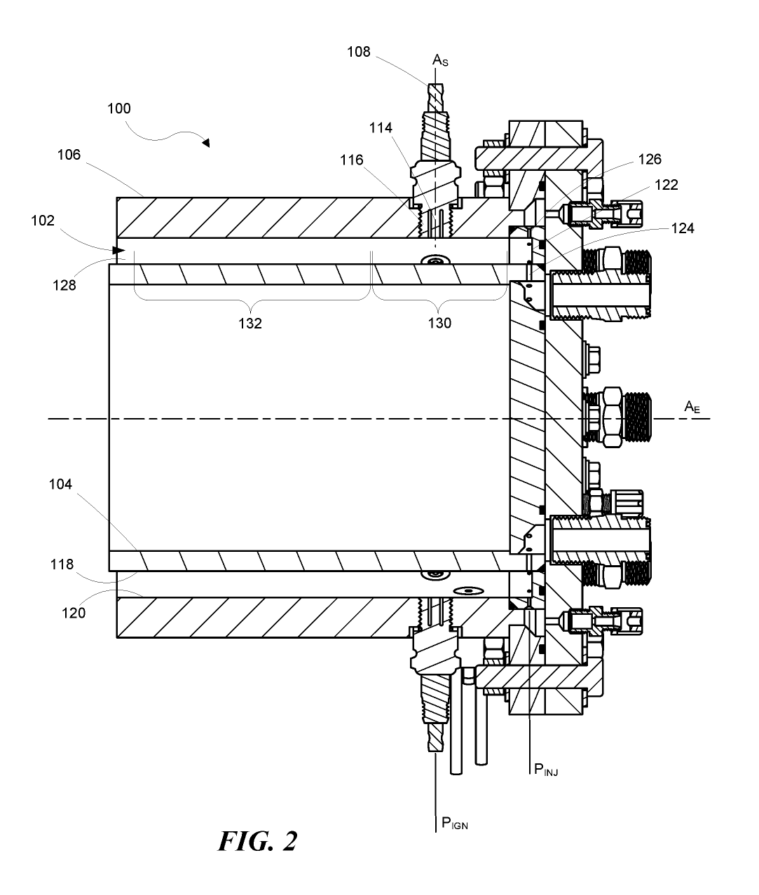

FIG. 2 is a side view in cross-section of the CRDE 100 shown in FIG. 1. As best seen in FIG. 2, in some embodiments, the ignition devices 108 may be so-called surface discharge type devices, wherein the arc is not oriented along the threaded axis A_{S} of the spark plug 108. Rather the arc occurs perpendicularly to the axis A_{S} and between a low-profile center electrode 114 and a low-profile grounded plug surface 116. In some embodiments, the center electrode 114 may be positioned along the threaded axis A_{S} of the spark plug 108, while the grounded plug surface 116 may be positioned radially from this axis, perpendicular to this axis, and/or co-planar with an electrode surface of the center electrode 114. The spark plugs 108 may be positioned at a radial depth such that the electrode surface of the plug is neither protruded nor recessed from an outer surface 120 of the annular chamber 102. In other words, the electrode surface may be flush with the outer surface 120 of the annular chamber 102. Using such spark plugs 108 is expected to ensure that the hemispherical shock waves emitted by the plugs may propagate unimpeded in the intended direction while also mitigating any interaction with the gas flow within the combustion chamber 102.

The inner and outer cylindrical shells 104/106 extend along an engine axis A_{E} to partially define the annular combustion chamber 102. The annular combustion chamber 102 has an inner combustion chamber surface 118, an outer combustion chamber surface 120, and an end surface 122. The annular chamber 102 includes an exhaust opening 128 opposite the end surface 122. A plurality of inner injection openings 124 are located proximate the chamber end surface 122 and extend through the inner chamber surface 118 for fluid communication with the combustion chamber 102. A plurality of outer injection openings 126 are located proximate the chamber end surface 122 and extend through the outer chamber surface 120 for fluid communication with the combustion chamber 102. In operation, as oxidizer and fuel (not shown) enter the combustion chamber 102 through the inner and outer injection openings 124 and 126, respectively, the oxidizer and fuel mix together in a mixing zone 130 prior to being ignited or detonated in a detonation zone 132.

The mixing zone 130 is expected to protect the spark plugs 108 from direct exposure to the high temperature detonation gas, and also acts as a buffer between the detonation zone 132 and the inner and outer injection openings 124 and 126 (e.g., oxidizer/fuel injection). The radial jets of oxidizer and fuel from the inner and outer injection openings 124 and 126 provide a radial curtain to block any backflow from the detonation zone 132.

In some embodiments, the plurality of ignition devices 108 each extend along an ignition plane P_{IGN} oriented perpendicular to the engine axis A_{E}. In other words, the ignition devices 108 each extend along a corresponding axis A_{S} lying in the ignition plane P_{IGN}. Similarly, the inner and outer injection openings 124/126 each extend along an injection plane P_{INJ} oriented perpendicular to the engine axis A_{E}. However, in other embodiments, the ignition devices 108, the inner injection openings 124, and/or the outer injection openings 126 can be arranged in a spiral or other suitable pattern around the combustion chamber 102. In some embodiments, the ignition devices 108 and/or the inner and outer injection openings 124/126 extend radially into the combustion chamber 102. In other embodiments, the ignition devices 108 and/or the inner and outer injection openings 124/126 can extend into the combustion chamber 102 at an angle with respect to the radial or normal direction. For example, the injection openings 124/126 can be circumferentially angled in the same direction around the combustion chamber 102 in order to direct fuel and oxidizer in a selected rotational direction within the combustion chamber 102.

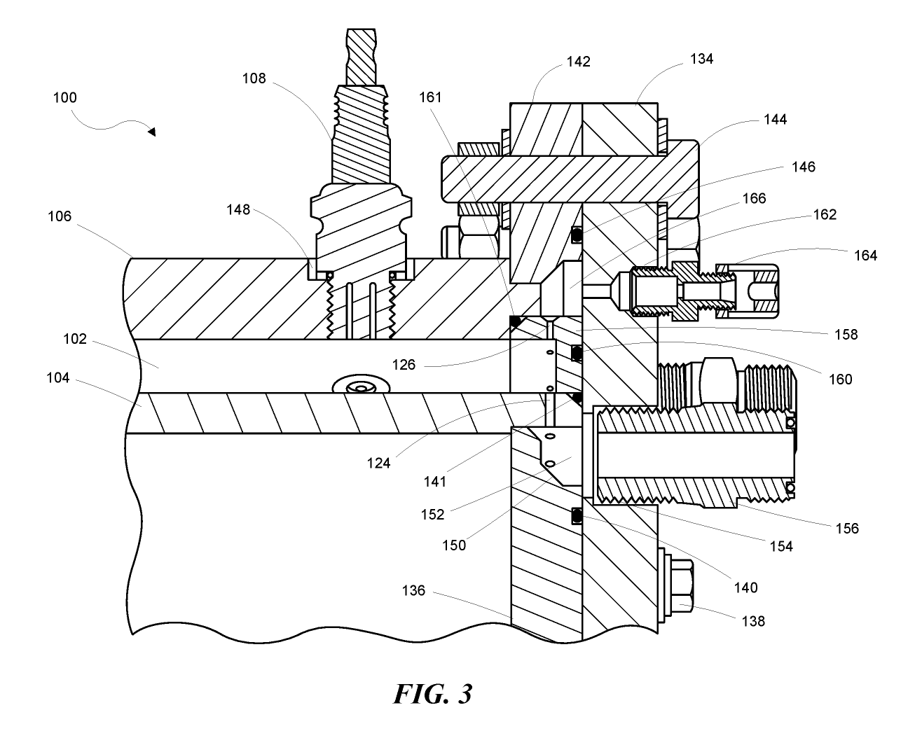

FIG. 3 is an enlarged portion of the cross-section shown in FIG. 2. In this embodiment, the inner cylindrical shell 104 and the outer cylindrical shell 106 are attached to an end plate 134. The inner cylindrical shell 104 is welded to an inner manifold plate 136 that is bolted to the end plate 134 with fasteners (e.g., cap screws) 138. The inner manifold plate 136 is sealed against the end plate 134 with an o-ring 140 and the inner cylindrical shell 104 is sealed against the end plate 134 with an o-ring 141. The outer cylindrical shell 106 is welded to a flange 142, which is bolted to the end plate 134 with suitable nut and bolt arrangements 144. The flange 142 is sealed against the end plate 134 with an o-ring 146. The outer cylindrical shell 106 includes a plurality of ignition ports 148, each configured (e.g., threaded) to receive a corresponding one of the ignition devices 108.

The inner manifold plate 136 includes a groove 150 formed around its circumference, which forms an inner annular manifold chamber 152 when assembled against the end plate 134. The end plate 134 includes one or more oxidizer inlet ports 154 connected to the inner manifold chamber 152, each configured to receive a suitable tube fitting 156. The inner injection openings 124 are formed (e.g., drilled) through the inner cylindrical shell 104 such that they are in fluid communication with the inner manifold chamber 152 and the combustion chamber 102. Accordingly, oxidizer supplied to the tube fittings 156 can travel through the inlet ports 154, the inner manifold chamber 152, and through the inner injection openings 124 into the combustion chamber 102.

A manifold insert 158 is positioned between the outer cylindrical shell 106 and the end plate 134. The manifold insert 158 can be sealed against the end plate with an o-ring 160 and sealed against the outer cylindrical shell 106 with an o-ring 161. The outer injection openings 126 are formed through the manifold insert 158 for fluid communication with the combustion chamber 102 and an outer manifold chamber 166. The outer manifold chamber 166 is formed between the outer cylindrical shell 106, the flange 142, the end plate 134 and the manifold insert 158. The end plate 134 includes one or more fuel inlet ports 162 connected to the outer manifold chamber 166, each configured to receive a suitable tube fitting 164. Accordingly, fuel supplied to the tube fittings 164 can travel through the inlet ports 162, the outer manifold chamber 166, and through the outer injection openings 126 into the combustion chamber 102. Although the depicted embodiment is described with the oxidizer entering the combustion chamber 102 from the inner injection openings 124 and the fuel entering through the outer injection openings 126, the fuel and oxidizer supplies could be reversed. Furthermore, in some embodiments, fuel can be supplied to some of the inner injection openings 124 and some of the outer injection openings 126 while oxidizer is supplied to the remaining inner and outer injection openings 124/126.

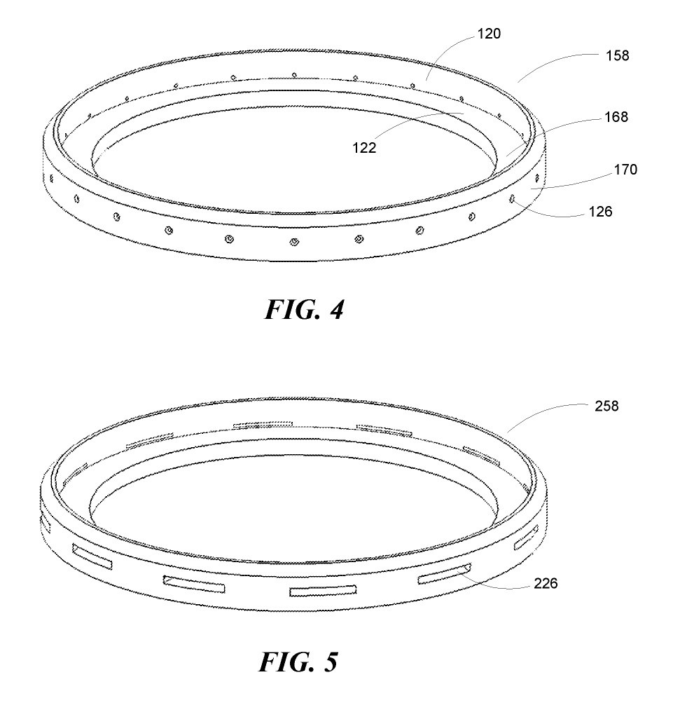

FIG. 4 is an isometric view of the manifold insert 158 before installation with the CRDE 100 (FIG. 3). The manifold insert 158 includes a radially extending wall 168 and a surrounding sidewall 170 extending axially therefrom. The sidewall 170 includes the plurality of outer injection openings 126. It should be appreciated that the sidewall 170 comprises a portion of the outer combustion chamber surface 120 and the radially extending wall 168 includes the combustion chamber end surface 122. Although the inner and outer injection openings 124/126 are shown as round holes, other injection opening configurations can be used. For example, FIG. 5 illustrates a manifold insert 258 configured in accordance with another embodiment of the present technology. The manifold insert 258 is constructed similarly to manifold insert 158; however, the outer injection openings 226 are configured as circumferentially extending slots. It should be understood that the inner injection openings 124 can also have different configurations, such as slotted openings.

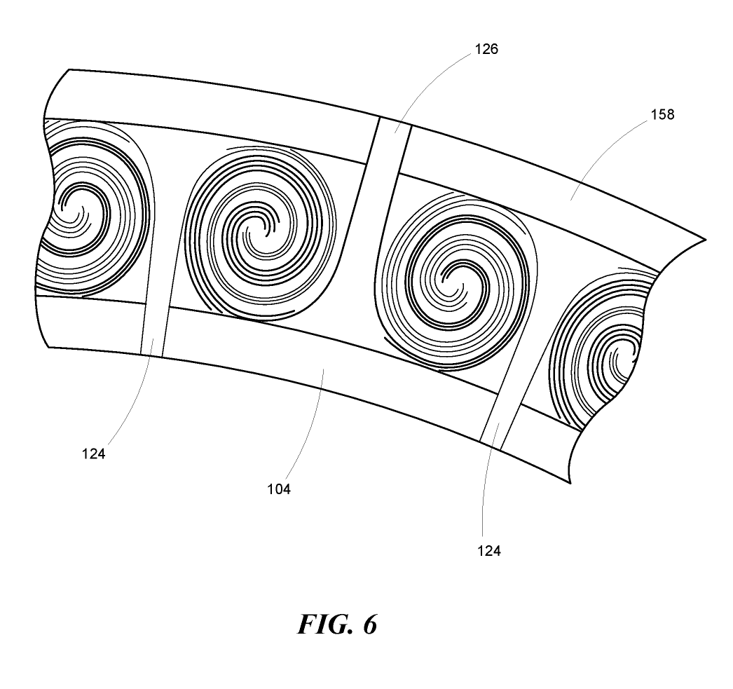

FIG. 6 is a schematic diagram of fuel and oxidizer mixing as viewed from an end of the CRDE 100. In some embodiments, the inner and outer injection openings 124/126 can be circumferentially offset from each other. The offset, radial, and counter flow injection of fuel and oxidizer from a discrete number of injection holes 124/126 achieves the requisite mixing of reactants at the end of the mixing zone 130 (FIG. 2), located at a sufficient distance from the ignition devices 108 (FIG. 2), to protect the ignition devices 108 from the direct exposure to the detonation waves. Mixing of the fuel and oxidizer occurs when vortices, formed around the injected jets, roll up and entrain fluid particles. By providing injection through a modest number of sparsely located holes 124/126, the mixing rate can be modulated in such a way that full mixing, where detonation occurs, is achieved sufficiently downstream of the injection holes 124/126. The mixing zone 130 (FIG. 2) protects the spark system from direct exposure to the high temperature detonation gas, but also acts as a buffer between the detonation zone 132 (FIG. 2) and oxidizer/fuel injection openings 124/126. The radial jets of oxidizer and fuel provide a radial curtain to block the backflow.

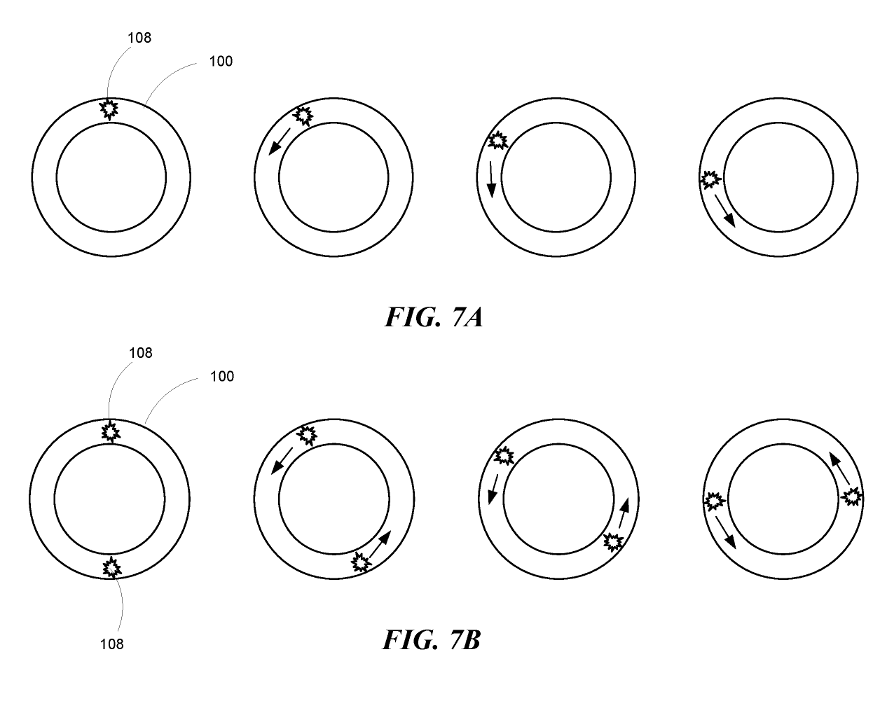

The CRDE 100 does not use a pre-detonator to initiate combustion and rotation as does conventional CRDEs. Instead, as illustrated schematically in FIGS. 7A and 7B, the CRDE 100 starts directly by sequential activation of the spark plugs 108. By placing the spark plugs 108 circumferentially and activating them in consecutive sequence, as shown in FIG. 7A, counterclockwise spinning disturbances can be created in an orderly manner. Many variations of this direct detonation method as applicable to the generation of desired number of waves are possible. For example, as shown in FIG. 7B, diametrically opposed spark plugs 108 can be activated in sequence around the CRDE 100. Although one-quarter of a revolution is illustrated in FIGS. 7A and 7B, it should be understood that the spark plugs 108 can be activated for several hundred complete revolutions to initiate combustion in the desired rotational direction. Furthermore, the rotation can be directed in either direction, e.g., clockwise or counter-clockwise. Once the detonation starts, activation of the ignition devices 108 can be stopped because the detonation waves become self-sustained and continue to spin without any external aid. Should, for any reason, the detonation waves cease to spin, the ignition devices 108 can be activated to resume operation.

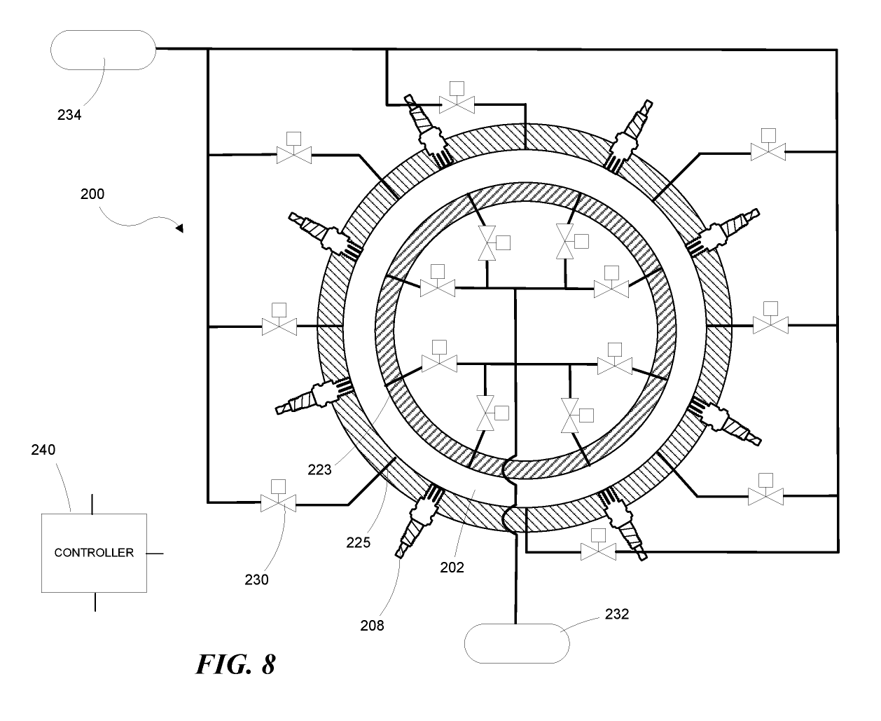

FIG. 8 schematically illustrates a CRDE 200 configured in accordance with another embodiment of the present technology. Rather than feeding fuel and oxidizer to the combustion chamber 200 with inner and outer manifold chambers, each injection opening 223/225 is coupled to a corresponding control valve 230 which is in turn connected to either a fuel supply 232 or an oxidizer supply 234. Accordingly, fuel and oxidizer can be introduced into the combustion chamber 202 in sequence around the circumference of the combustion chamber 202. In some embodiments, the valves 230 are activated in the same direction as the ignition devices 208. In other embodiments, the valves 230 are activated in a direction counter to the ignition devices 208. The activation of each individual control valve 230 and spark plug 208 may be controlled by one or more controllers, such as controller 240. Thus, the mixture of fuel and oxidizer in different locations in the combustion chamber 202 can be controlled based on selective control of the valves 230 by the controller 240. The controller 240 may be implemented in hardware and/or a combination of hardware and software. Instructions for performing certain actions to control the CRDE 200 may be stored in non-transitory, machine-readable storage media for subsequent execution by one or more processors and/or other types of circuits.

Also disclosed herein are methods for operating a continuous rotating detonation engine. In a representative embodiment, the method comprises sequentially activating a plurality of ignition devices positioned around an annular combustion chamber and radially injecting fuel and oxidizer into the annular combustion chamber. In some embodiments, the plurality of ignition devices can be activated in diametrically opposed pairs. In other embodiments, the plurality of ignition devices can be activated in consecutive sequence around the combustion chamber. The plurality of ignition devices, for example, may be activated in consecutive sequence around the combustion chamber for a preselected number of revolutions (e.g., 100-300 revolutions). In some embodiments, the fuel and oxidizer are injected at a plurality of locations around an inner and an outer circumference of the combustion chamber. In some embodiments, the plurality of ignition devices can be activated prior to injection of the fuel and oxidizer.

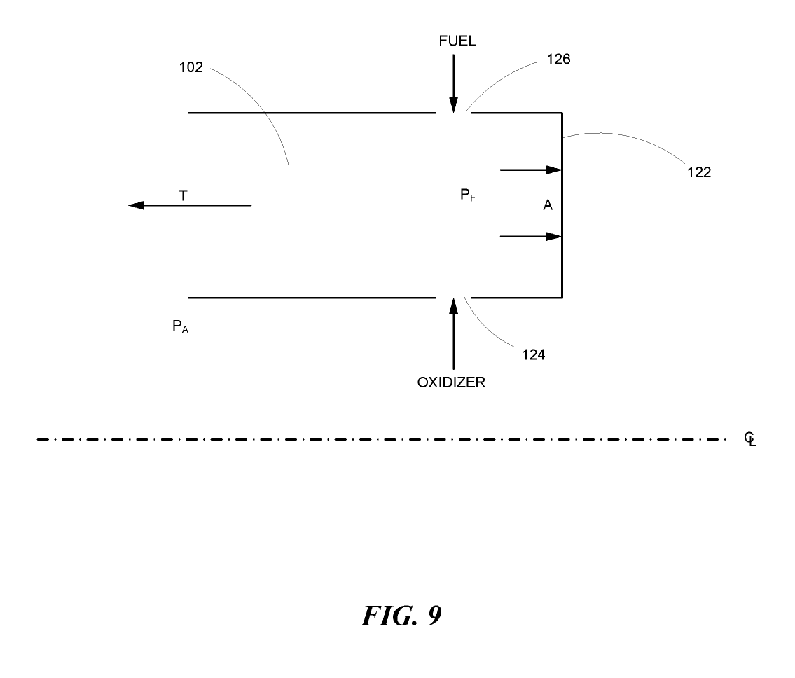

One feature of CRDEs having configurations in accordance with embodiments of the technology described herein is that the end wall surface does not have any holes. An advantage of this arrangement is that the entire end wall surface is available to produce thrust. FIG. 9, for example, is a schematic diagram illustrating a portion of a combustion chamber configured in accordance with the present technology. As shown in FIG. 9, the combustion chamber end surface 122 of the combustion chamber 102 does not have any holes, thus maximizing the area A against which the combustion pressure P_{F} acts. By locating the injection openings 124/126 radially, the full area of the end surface 122 is available to react against the combustion pressure P_{F}.

Thrust T of the CRDE can be calculated as the difference in pressure between the combustion pressure P_{F} and ambient air pressure P_{A} multiplied by the end surface area A:

T=A*(P_{F}−P_{A})

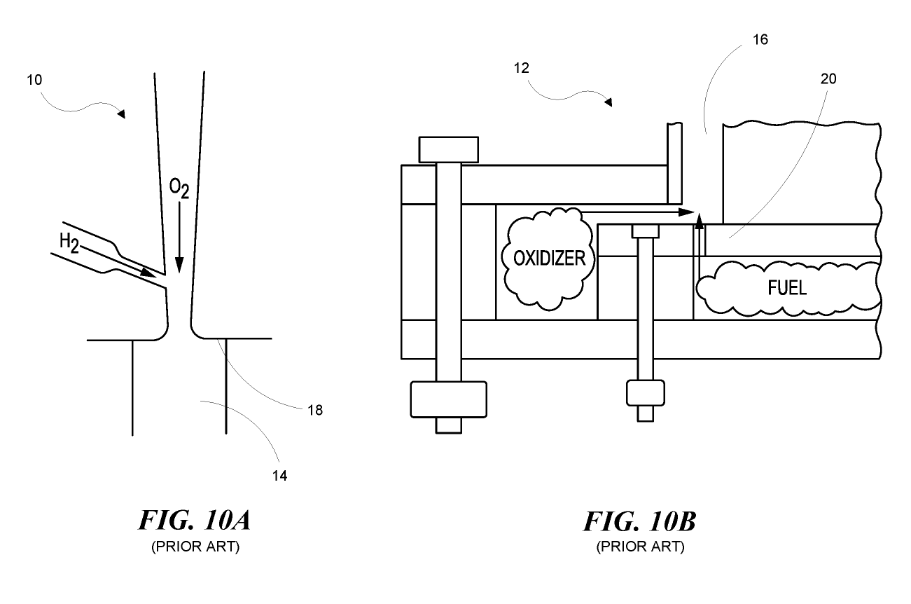

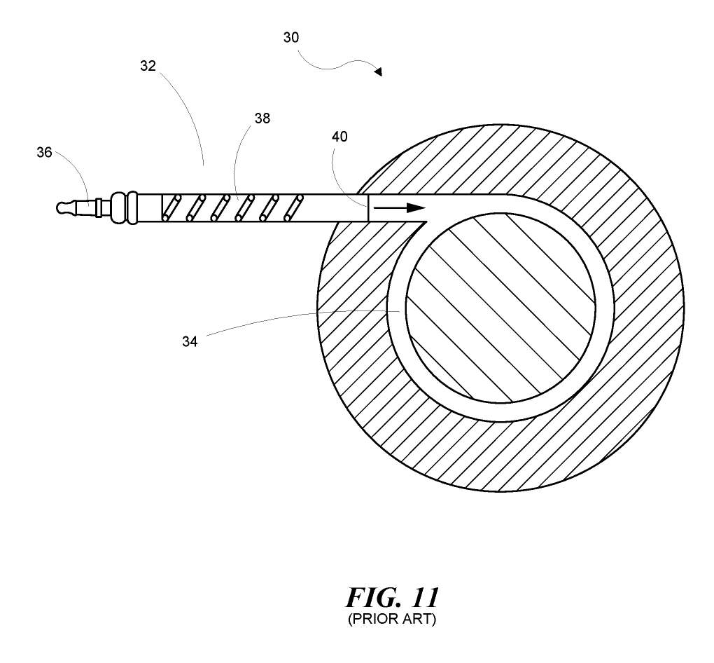

In contrast with the present technology, FIGS. 10A and 10B illustrate conventional CRDE configurations 10 and 12, respectively, where the fuel and/or oxidizer are introduced into the combustion chambers 14/16 axially through the end wall surfaces 18/20. One drawback associated with these conventional configurations is that such arrangements reduce the area against which the combustion pressure acts, thereby reducing thrust output of the CRDE.

Another feature of CRDEs having configurations in accordance with embodiments of the technology described herein is that the initial detonation waves are created with sequentially activated ignition devices. One advantage of this arrangement is that it enables the waves to spin in a specified direction without any spontaneous spin reversals, and the system can quickly reach a stable steady state (e.g., self-sustained detonation). Such an arrangement is expected to be more efficient and reliable than conventional CRDE arrangements. For example, referring to FIG. 11, the conventional way to start a CRDE, such as CRDE 30, is the use of a pre-detonator 32. A plane detonation wave 40 is generated by a discharge (e.g., spark plug 36) in a separate tube 38 extending into the annular section 34 of the CRDE 30. The shock from the pre-detonator 32 is injected tangentially to the annular section 34 and is intended to initiate a clockwise spinning detonation wave which is supposed to transit self-sustained detonation waves. However, it has been observed that two waves, one spinning clockwise and the other in a counter-clockwise direction, are simultaneously generated. When the two counter-rotating waves collide, it causes instability and a failure to establish self-sustained detonation.

The disclosure may be defined by one or more of the following examples:

1. A continuous rotating detonation engine, comprising:
an annular combustion chamber formed between substantially concentric inner and outer cylindrical shells;
a plurality of ignition devices extending into the annular combustion chamber and positioned around a circumference of at least one of the inner and outer cylindrical shells, wherein each ignition device is operative to provide ignition energy to the combustion chamber upon respective activation thereof; and
a plurality of injection openings extending through at least one of the inner and outer cylindrical shells for fluid communication with the annular combustion chamber.

2. The continuous rotating detonation engine of example 1 wherein:
the inner and outer cylindrical shells extend along an engine axis; and
the plurality of ignition devices are equidistantly spaced around the circumference of the outer cylindrical shell, each extending along an ignition plane oriented perpendicular to the engine axis; and
the plurality of injection openings include inner injection openings and outer injection openings extending through the inner and outer cylindrical shells, respectively, the inner injection openings being circumferentially offset from the outer injection openings; and
the inner and outer injection openings each extend along an injection plane oriented perpendicular to the engine axis.

3. The continuous rotating detonation engine of example 1 or example 2, further comprising:
a controller including instructions to activate the plurality of ignition devices in consecutive sequence around the circumference of the outer cylindrical shell for a preselected number of revolutions; and
an inner annular manifold in fluid communication with the inner injection openings and connectable to one of a source of oxidizer and a source of fuel, and an outer annular manifold in fluid communication with the outer injection openings and connectable to the other of the source of oxidizer and the source of fuel, and
wherein the plurality of injection openings and the plurality of ignition devices each extend radially into the combustion chamber.

4. The continuous rotating detonation engine of any one of examples 1, 2, or 3, further comprising a controller including instructions for providing output signals for selective activation of each of the plurality of ignition devices.

5. The continuous rotating detonation engine of any one of examples 1-4 wherein the controller includes instructions to activate the plurality of ignition devices in consecutive sequence around the circumference of the at least one of the inner and outer cylindrical shells.

6. The continuous rotating detonation engine of any one of examples 1-4 wherein the controller includes instructions to activate the plurality of ignition devices in diametrically opposed pairs.

7. The continuous rotating detonation engine of any one of examples 1-6 wherein the inner and outer cylindrical shells extend along an engine axis and the plurality of ignition devices extend along an ignition plane perpendicular to the engine axis.

8. The continuous rotating detonation engine of any one of examples 1-7 wherein the plurality of injection openings and the plurality of ignition devices extend radially into the combustion chamber.

9. A continuous rotating detonation engine, comprising:
an outer cylindrical shell;
an inner cylindrical shell positioned concentrically within the outer cylindrical shell to at least partially define an annular combustion chamber therebetween;
a chamber end wall extending between the outer cylindrical shell and the inner cylindrical shell;
a plurality of ignition ports extending radially through at least one of the inner and outer cylindrical shells and into the combustion chamber;
a plurality of outer injection openings located proximate the chamber end wall and extending radially through an outer surface of the combustion chamber; and
a plurality of inner injection openings located proximate the chamber end wall and extending radially through an inner surface of the combustion chamber.

10. The continuous rotating detonation engine of example 9 wherein the inner and outer cylindrical shells extend along an engine axis and the end wall lies on an end plane perpendicular to the engine axis.

11. The continuous rotating detonation engine of example 9 or 10, further comprising an inner annular manifold in fluid communication with the plurality of inner injection openings and an outer annular manifold in fluid communication with the plurality of outer injection openings, each of the inner and outer manifolds connectable to one or the other of a source of oxidizer and a source of fuel.

12. The continuous rotating detonation engine of example 9, 10, or 11, further comprising a plurality of spark plugs each coupled to a corresponding one of the plurality of ignition ports and operative to provide ignition energy to the combustion chamber upon activation thereof.

13. The continuous rotating detonation engine of any one of examples 9-12, further comprising a controller including instructions to activate the plurality of spark plugs in consecutive sequence around a circumference of the combustion chamber.

14. The continuous rotating detonation engine of any one of examples 9-13 wherein the plurality of inner injection openings are circumferentially offset from the plurality of outer injection openings.

15. The continuous rotating detonation engine of any one of examples 9-14 wherein the inner and outer injection openings each extend along an injection plane oriented perpendicular to the engine axis.

16. A method of operating a continuous rotating detonation engine, the method comprising:
sequentially activating a plurality of ignition devices positioned around an annular combustion chamber;
radially injecting a fuel into the annular combustion chamber in a first direction; and
radially injecting an oxidizer into the annular combustion chamber in a second direction generally opposite the first direction.

17. The method of example 16 wherein the plurality of ignition devices are activated in diametrically opposed pairs.

18. The method of example 16 or 17 wherein the plurality of ignition devices are activated in consecutive sequence around the combustion chamber.

19. The method of example 16, 17, or 18 wherein the plurality of ignition devices are activated in consecutive sequence around the combustion chamber for a preselected number of revolutions.

20. The method of any one of examples 16-19, further comprising injecting the fuel and oxidizer at a plurality of locations around an inner and an outer circumference of the combustion chamber.

The above detailed descriptions of embodiments of the technology are not intended to be exhaustive or to unnecessarily limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Where the context permits, singular or plural terms may also include the plural or singular term, respectively. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A continuous rotating detonation engine, comprising:
an annular combustion chamber formed between substantially concentric inner and outer cylindrical shells;
a plurality of ignition devices extending into the annular combustion chamber and positioned around a circumference of at least one of the inner and outer cylindrical shells, wherein each ignition device is operative to provide ignition energy to the combustion chamber upon respective activation thereof; and
a plurality of injection openings extending through at least one of the inner and outer cylindrical shells for fluid communication with the annular combustion chamber.

2. The continuous rotating detonation engine of claim 1 wherein:
the inner and outer cylindrical shells extend along an engine axis; and
the plurality of ignition devices are equidistantly spaced around the circumference of the outer cylindrical shell, each extending along an ignition plane oriented perpendicular to the engine axis; and
the plurality of injection openings include inner injection openings and outer injection openings extending through the inner and outer cylindrical shells, respectively, the inner injection openings being circumferentially offset from the outer injection openings; and
the inner and outer injection openings each extend along an injection plane oriented perpendicular to the engine axis.

3. The continuous rotating detonation engine of claim 2 further comprising:
a controller including instructions to activate the plurality of ignition devices in consecutive sequence around the circumference of the outer cylindrical shell for a preselected number of revolutions; and
an inner annular manifold in fluid communication with the inner injection openings and connectable to one of a source of oxidizer and a source of fuel, and an outer annular manifold in fluid communication with the outer injection openings and connectable to the other of the source of oxidizer and the source of fuel, and
wherein the plurality of injection openings and the plurality of ignition devices each extend radially into the combustion chamber.

4. The continuous rotating detonation engine of claim 1, further comprising a controller including instructions for providing output signals for selective activation of each of the plurality of ignition devices.

5. The continuous rotating detonation engine of claim 4 wherein the controller includes instructions to activate the plurality of ignition devices in consecutive sequence around the circumference of the at least one of the inner and outer cylindrical shells.

6. The continuous rotating detonation engine of claim 4 wherein the controller includes instructions to activate the plurality of ignition devices in diametrically opposed pairs.

7. The continuous rotating detonation engine of claim 1 wherein the inner and outer cylindrical shells extend along an engine axis and the plurality of ignition devices extend along an ignition plane perpendicular to the engine axis.

8. The continuous rotating detonation engine of claim 1 wherein the plurality of injection openings and the plurality of ignition devices extend radially into the combustion chamber.

9. A continuous rotating detonation engine, comprising:
an outer cylindrical shell;
an inner cylindrical shell positioned concentrically within the outer cylindrical shell to at least partially define an annular combustion chamber therebetween;
a chamber end wall extending between the outer cylindrical shell and the inner cylindrical shell;
a plurality of ignition ports extending radially through at least one of the inner and outer cylindrical shells and into the combustion chamber;
a plurality of outer injection openings located proximate the chamber end wall and extending radially through an outer surface of the combustion chamber; and
a plurality of inner injection openings located proximate the chamber end wall and extending radially through an inner surface of the combustion chamber.

10. The continuous rotating detonation engine of claim 9 wherein the inner and outer cylindrical shells extend along an engine axis and the end wall lies on an end plane perpendicular to the engine axis.

11. The continuous rotating detonation engine of claim 9, further comprising an inner annular manifold in fluid communication with the plurality of inner injection openings and an outer annular manifold in fluid communication with the plurality of outer injection openings, each of the inner and outer manifolds connectable to one or the other of a source of oxidizer and a source of fuel.

12. The continuous rotating detonation engine of claim 9, further comprising a plurality of spark plugs each coupled to a corresponding one of the plurality of ignition ports and operative to provide ignition energy to the combustion chamber upon activation thereof.

13. The continuous rotating detonation engine of claim 12, further comprising a controller including instructions to activate the plurality of spark plugs in consecutive sequence around a circumference of the combustion chamber.

14. The continuous rotating detonation engine of claim 9 wherein the plurality of inner injection openings are circumferentially offset from the plurality of outer injection openings.

15. The continuous rotating detonation engine of claim 9 wherein the inner and outer injection openings each extend along an injection plane oriented perpendicular to the engine axis.

16. A method of operating a continuous rotating detonation engine, the method comprising:
sequentially activating a plurality of ignition devices positioned around an annular combustion chamber;
radially injecting a fuel into the annular combustion chamber in a first direction; and
radially injecting an oxidizer into the annular combustion chamber in a second direction generally opposite the first direction.

17. The method of claim 16 wherein the plurality of ignition devices are activated in diametrically opposed pairs.

18. The method of claim 16 wherein the plurality of ignition devices are activated in consecutive sequence around the combustion chamber.

19. The method of claim 18 wherein the plurality of ignition devices are activated in consecutive sequence around the combustion chamber for a preselected number of revolutions.

20. The method of claim 16, further comprising injecting the fuel and oxidizer at a plurality of locations around an inner and an outer circumference of the combustion chamber.
